(19) United States
(12) Patent Application Publication
(10) Pub. No.: US 2013/0108284 A1
(43) Pub. Date: May 2, 2013

(54) IMAGE FORMING APPARATUS

(71) Applicant: Sharp Kabushiki Kaisha, Osaka (JP)

(72) Inventor: Sohichi Takata, Osaka (JP)

(73) Assignee: Sharp Kabushiki Kaisha, Osaka (JP)

(21) Appl. No.: 13/666,354

(22) Filed: Nov. 1, 2012

(30) Foreign Application Priority Data
Nov. 1, 2011 (JP) 2011240178

(51) Int. Cl. G03G 15/00

(52) U.S. Cl. 399/21

(57) ABSTRACT

An image forming apparatus includes a paper transfer path through which a sheet of paper is to be transferred, a transfer unit (for example, transfer rollers) to reciprocatably transfer the sheet of paper through the paper transfer path, a housing door openable to expose the paper transfer path, an open-close sensor to detect whether the housing door is open or closed, a paper sensor disposed along the paper transfer path to detect a position of the sheet of paper, and a paper jam determination unit to determine whether a paper jam has occurred in the paper transfer path based on a result of detection by the paper sensor. When the paper jam determination unit determines that a paper jam has occurred and when the housing door is opened, the transfer unit transfers the sheet of paper in a reverse direction.

### CROSS-REFERENCE TO RELATED APPLICATIONS

The present application claims priority under 35 U.S.C. §119(a) to Japanese Patent Application No. 2011-240178, filed Nov. 1, 2011. The contents of this application are herein incorporated by reference in their entirety.

### FIELD OF THE INVENTION

The present invention relates to an image forming apparatus provided with transfer means for reciprocatably transferring a sheet of paper through a paper transfer path.

### CONVENTIONAL ART

Conventionally, image forming apparatuses occasionally encounter transfer failure and paper jams due to various causes during transfer of sheets of paper. In such case, a user has had to open the housing of the image forming apparatus to remove residual sheets of paper left inside the image forming apparatus.

Incidentally, in recent years, image forming apparatuses are becoming smaller in size and more complicated, making the interior space smaller. This has caused a problem in that it is difficult to insert a hand into the image forming apparatus in an attempt to remove a residual sheet of paper. Additionally, when a residual sheet of paper is located somewhere a hand cannot reach to grasp the sheet of paper, it is even more difficult to remove the sheet of paper.

In view of this problem, some image forming apparatuses are under development to address to transfer failure. When paper jam occurs, transfer means for transferring a sheet of paper is driven into reverse rotation to transfer the sheet of paper in the reverse direction, thereby eliminating the paper jam in the transfer path (see, for example, patent document 1). [Patent Document 1] Japanese Unexamined Patent Application Publication No. 2007-191274.

### SUMMARY OF THE INVENTION

Incidentally, complicated image forming apparatuses at times contain inhibitors of transfer of a sheet of paper in the reverse direction, examples including sensors disposed along the transfer path. Unfortunately, in the image forming apparatus recited in patent document 1, the sheets of paper in a jam are transferred through a hermetically sealed transfer path, creating a possibility of the sheets of paper being stuck to result in another failure.

The present invention has been made in view of the above-described circumstances, and it is an object of the present invention to provide an image forming apparatus that transfers a sheet of paper with the paper transfer path in exposed state, thereby preventing a secondary paper jam.

An image forming apparatus according to the present invention is provided with a paper transfer path through which a sheet of paper is to be transferred, and provided with a transfer unit configured to reciprocatably transfer the sheet of paper through the paper transfer path. The image forming apparatus includes a housing door, an open-close sensor, a paper sensor, and a paper jam determination unit. The housing door is openable to expose the paper transfer path. The open-close sensor is configured to detect whether the housing door is open or closed. The paper sensor is disposed along the paper transfer path to detect a position of the sheet of paper. The paper jam determination unit is configured to determine whether a paper jam has occurred in the paper transfer path based on a result of detection by the paper sensor. When the paper jam determination unit determines that a paper jam has occurred and when the housing door is opened, the transfer unit is configured to transfer the sheet of paper in a reverse direction.

With this configuration, when a paper jam occurs, the sheet of paper is transferred in the reverse direction to eliminate the paper jam occurring in the paper transfer path. Additionally, the sheet of paper is transferred with the paper transfer path in exposed state, thereby preventing a secondary paper jam.

The image forming apparatus according to the present invention may include a notification unit configured to notify that the paper jam determination unit determines that a paper jam has occurred.

With this configuration, the notification unit makes a user aware of an occurrence of paper jam.

In the image forming apparatus according to the present invention, the notification unit may be configured to notify that the transfer unit transfers the sheet of paper in the reverse direction after the housing door is opened.

With this configuration, making the user aware in advance that the transfer unit is about to operate eliminates transfer failure caused by the user erroneously trying to remove the sheet of paper during transfer of the sheet of paper.

The image forming apparatus according to the present invention may include a non-exposed portion disposed along the paper transfer path. The non-exposed portion is not exposed when the housing door is opened. When the paper jam determination unit determines that a paper jam has occurred at the non-exposed portion, the transfer unit may be configured to transfer the sheet of paper to a part of the paper transfer path that is outside of the non-exposed portion.

When a paper jam occurs at the non-exposed portion, the sheet of paper is difficult to remove even by opening the housing door. In view of this, in the above-described configuration, the sheet of paper is transferred to outside of the non-exposed portion. This improves workability of the user in removing the sheet of paper.

In the image forming apparatus according to the present invention, the transfer unit may include a plurality of roller pairs configured to hold the sheet of paper between each of the roller pairs and configured to rotate so as to transfer the sheet of paper. When the paper jam determination unit determines that a paper jam has occurred and when the plurality of roller pairs are holding the sheet of paper between each of the plurality of roller pairs, one roller pair among the plurality of roller pairs disposed on a downstream side of the paper transfer path may be configured to rotate.

With this configuration, when only one roller pair rotates to transfer the sheet of paper, the sheet of paper becomes loose and easier to grasp, thereby improving workability of the user in removing the sheet of paper.

### BRIEF DESCRIPTION OF THE DRAWINGS

FIG. 1 is a side view of an image forming apparatus according to an embodiment of the present invention, illustrating a schematic configuration of the image forming apparatus;

FIG. 2A is a perspective view of the image forming apparatus shown in FIG. 1 with a housing door in closed state;

FIG. 2B is a perspective view of the image forming apparatus shown in FIG. 1 with the housing door in open state;

FIG. 3 is an enlarged perspective view of an exposed paper transfer path shown in FIG. 2B;

FIG. 4 is a function configuration diagram illustrating a configuration of the functions of the image forming apparatus according to the embodiment of the present invention;

FIG. 5 is a main-elements side view of a part of a paper transfer path in the case of transfer of a sheet of paper with the housing door in closed state, with FIG. 5(a) showing a state before transfer of the sheet of paper and FIG. 5(b) showing a state after transfer of the sheet of paper;

FIG. 6 is a main-elements side view of a part of the paper transfer path in the case of transfer of a sheet of paper with the housing door in open state, with FIG. 6(a) showing a state before transfer of the sheet of paper and FIG. 6(b) showing a state after transfer of the sheet of paper;

FIG. 7 is a main-elements side view of a part of the paper transfer path in the case of transfer of a sheet of paper held between two transfer rollers, with FIG. 7(a) showing a state before transfer of the sheet of paper and FIG. 7(b) showing a state after transfer of the sheet of paper; and

FIG. 8 is a flowchart of the process of detecting a paper jam and transferring the sheet of paper in the reverse direction in the image forming apparatus according to the embodiment of the present invention.

### DESCRIPTION OF THE EMBODIMENTS

The image forming apparatus according to an embodiment of the present invention will be described by referring to the accompanying drawings.

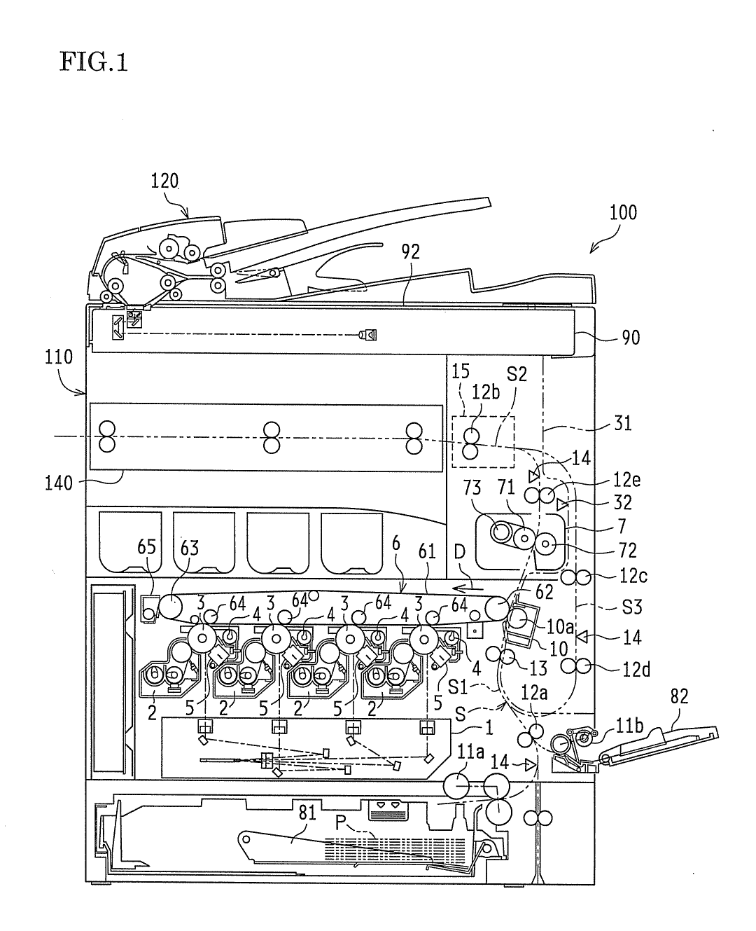

FIG. 1 is a side view of an image forming apparatus according to the embodiment of the present invention, illustrating a schematic configuration of the image forming apparatus.

An image forming apparatus 100 includes an apparatus main body 110 and an automatic document processing device 120. In accordance with externally transmitted image data, the image forming apparatus 100 forms a multicolor or monochrome image onto predetermined sheet of paper (document).

The apparatus main body 110 includes an exposure unit 1, a developer 2, a photosensitive drum 3, a cleaner unit 4, a charger 5, an intermediate transfer belt unit 6, and a fixing unit 7.

In addition to the above-described configuration, the image forming apparatus 100 includes a document reading device 90 that reads an image on a document, and an original stage 92 on which a document is placed. The document reading device 90 is disposed at an upper portion of the apparatus main body 110. The original stage 92 is made of transparent glass and disposed above the document reading device 90.

The automatic document processing device 120 is disposed above the original stage 92 to automatically transfer a document to the original stage 92. The automatic document processing device 120 is rotatable about an axis that couples the apparatus main body 110 and the automatic document processing device 120 to one another so that the original stage 92 is exposed and a document is manually placed onto the original stage 92.

The image forming apparatus 100 deals with image data that correspond to color images using colors including black (K), cyan (C), magenta (M), and yellow (Y). Accordingly, to form four kinds of latent images corresponding to the respective colors, the developer 2, the photosensitive drum 3 the charger 5, the cleaner unit 4 each come in four pieces respectively corresponding to black, cyan, magenta, and yellow, forming four image stations.

At each of the image stations, a toner image of the corresponding color is formed on the photosensitive drum 3 according to a known electrophotography process. The resulting toner images are sequentially transferred to an intermediate transfer belt 61 and superimposed onto each other. Thus, a color toner image (multicolor toner image) is formed on the intermediate transfer belt 61. The toner image is moved by rotation of the intermediate transfer belt 61 and transferred to a sheet of paper by the secondary transfer unit 10 disposed at the position of contact between the intermediate transfer belt 61 and the sheet of paper.

An intermediate transfer belt cleaning unit 65 removes and collects residual toner off the intermediate transfer belt 61. For example, the intermediate transfer belt cleaning unit 65 includes a cleaning blade as a cleaning member to come into contact with the intermediate transfer belt 61.

The fixing unit 7 includes a heating roller 71 and a pressure roller 72 that rotate a sheet of paper by holding it between the heating roller 71 and the pressure roller 72. The fixing unit 7 also includes an external heating belt 73 that externally heats the heating roller 71. The fixing unit 7 fuses, mixes, pressure-contacts the multicolor toner image transferred to the sheet so as to heat-fix the multicolor toner image onto the sheet.

The image forming apparatus 100 also includes a feeding cassette 81, a manual feeding cassette 82, and an intermediate unit 140. The feeding cassette 81 is a tray that stores sheets of paper P for use in image formation. The manual feeding cassette 82 also accepts sheets of paper P for use in image formation. The intermediate unit 140 is disposed in the apparatus main body 110 to forward an image-loaded sheet of paper P to other devices (such as a post-processing device). This, however, should not be construed in a limiting sense. It is also possible to use a storage tray instead of the intermediate unit 140.

The apparatus main body 110 includes a main transfer path S1 through which to transfer the sheets of paper from the feeding cassette 81 and the manual feeding cassette 82 to the intermediate unit 140 by way of a transfer roller 10a and the fixing unit 7. Along the main transfer path S1 from the feeding cassette 81 and the manual feeding cassette 82 to the intermediate unit 140, pick-up rollers 11a to 11b, resist rollers 13, the secondary transfer unit 10, and the fixing unit 7 are disposed. Along a paper transfer path S, a plurality of transfer rollers 12a to 12e are disposed to promote and aid transfer of a sheet of paper. The paper transfer path S includes the main transfer path S1, a switch-back transfer path S2, and a reverse transfer path S3.

The image forming apparatus 100 also includes a plurality of paper sensors 14. The paper sensors 14 are disposed along the paper transfer path S to detect the sheet of paper P in the paper transfer path S. Examples of the paper sensors 14 include actuators and light sensors. The number and positions of the paper sensors 14 may be set conveniently.

In this image forming apparatus 100, in one-sided image formation, a sheet of paper transferred from the feeding cassette 81 or the manual feeding cassette 82 is forwarded by the resist rollers 13 to the secondary transfer unit 10 in synchronization with the toner image on the intermediate transfer belt 61. Then, the toner image is transferred to the sheet of paper by the transfer roller 10a. Then, the sheet of paper is passed through the fixing unit 7 to heat the unfixed toner transferred to the sheet of paper, thereby fusing and fixing the sheet of paper. Thus, the toner image is fixed on the sheet of paper. The toner image-fixed sheet of paper is transferred to the intermediate unit 140.

In duplex image formation, the sheet of paper P past the fixing unit 7 at the end of the one-sided image formation is held between the transfer rollers 12b in the switch-back transfer path S2. Then, the transfer rollers 12b turn into reverse rotation to transfer the sheet of paper P to the reverse transfer path S3 with the sheet's upstream side end in the paper transfer path S as the forward end. The sheet of paper P transferred to the reverse transfer path S3 is guided to a further upstream position than the secondary transfer unit 10. Then, the sheet of paper P is passed through the resist rollers 13 and formed an image on the rear surface of the sheet of paper P. Then, the sheet of paper P is transferred to the intermediate unit 140.

The apparatus main body 110 includes a housing door 31 and an open-close sensor 32. The housing door 31 is openable by a user to partially expose the paper transfer path S. The open-close sensor 32 detects whether the housing door 31 is open or closed. In this embodiment, the housing door 31 is opened to expose the main transfer path S1. The transfer rollers 12b and the switch-back transfer path S2 constitute a non-exposed portion 15 not exposed when the housing door 31 is opened.

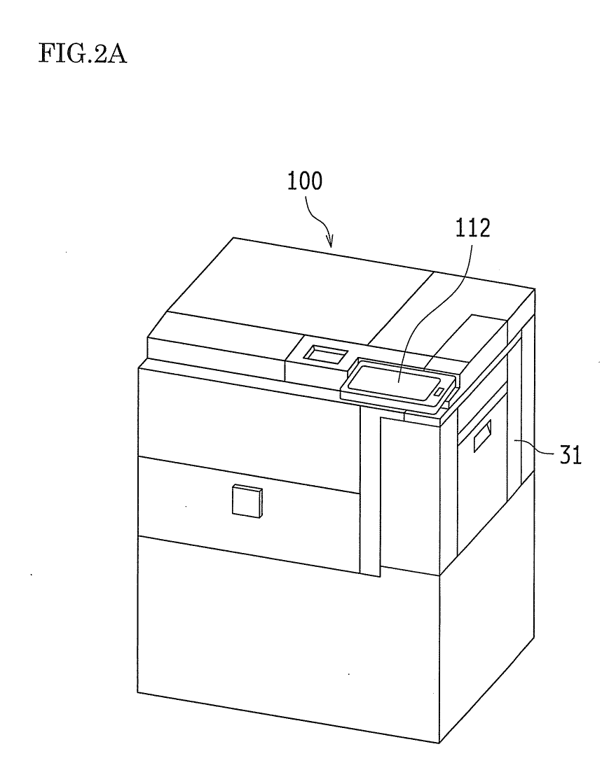

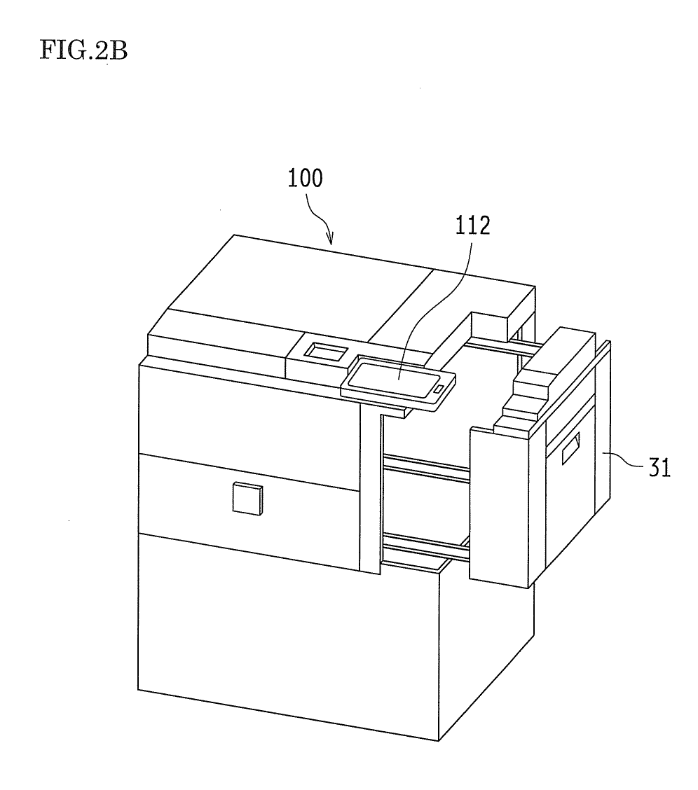

FIG. 2A is a perspective view of the image forming apparatus shown in FIG. 1 with the housing door in closed state. FIG. 2B is a perspective view of the image forming apparatus shown in FIG. 1 with the housing door in open state.

A display panel 112 is disposed on the upper surface of the image forming apparatus 100. The display panel 112 is a touch panel using a liquid crystal display with keys for the user to input instructions to, for example, execute image formation. The display panel 112 indicates settings for image formation such as the number of sheets of paper and paper size. The display panel 112 also shows a sentence or other indication notifying the user that a paper jam has occurred in the paper transfer path S. The image forming apparatus 100 may also include, in addition to the display panel 112, some buttons for the user to input instructions.

As described above, opening the housing door 31 exposes the paper transfer path S, and this provides necessary space for the user's work of removing a sheet of paper.

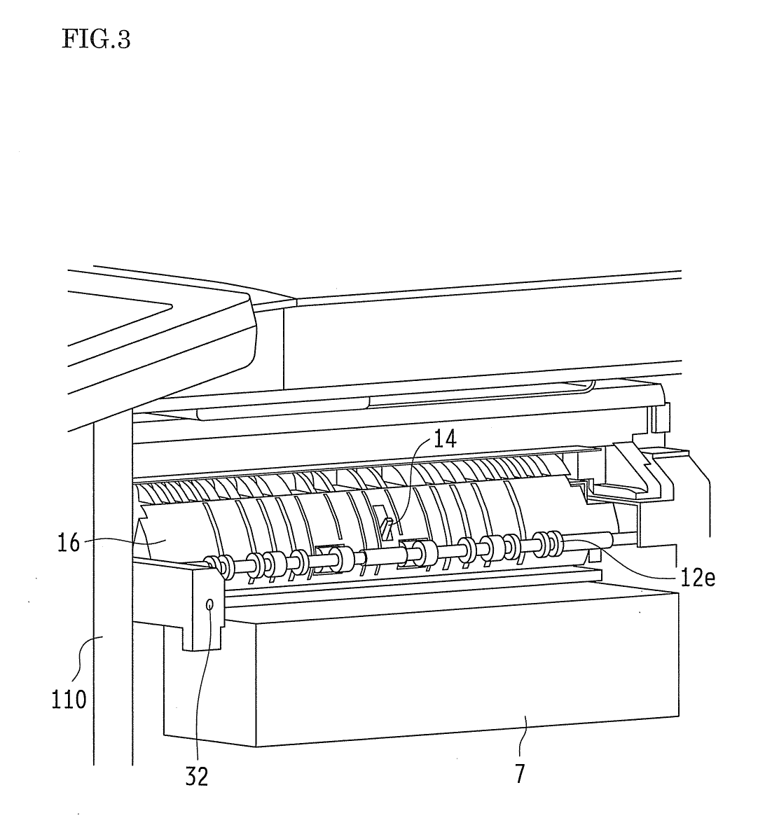

FIG. 3 is an enlarged perspective view of the exposed paper transfer path shown in FIG. 2B.

FIG. 3 enlarges, in particular, the vicinity of the fixing unit 7, the transfer rollers 12e, and a paper sensor 14.

The paper sensor 14 is an actuator that swings to detect a sheet of paper P. The paper sensor 14 protrudes from a transfer path side wall 16 of the apparatus main body 110 as if to interfere with the paper transfer path S, and swings into the transfer path side wall 16. When a sheet of paper P is transferred from the upstream side of the paper transfer path S and passed through the position where the paper sensor 14 is disposed, the actuator is pressed by the sheet of paper P into swinging movement. When, on the other hand, pressed by a sheet of paper P transferred from the downstream side of the paper transfer path S, the actuator does not make swinging movement.

The open-close sensor 32 is a drawer connector disposed on the inner wall of the apparatus main body 110. That is, the open-close sensor 32 detects whether current is flowing through the drawer connector to determine whether the housing door 31 is open or closed.

The transfer rollers 12a to 12e each constitute a roller pair of opposed rollers each having a rotation axis. The rotation axis is coupled to driving means, not shown, and reciprocatably rotates. The rotation axes of the transfer rollers 12e as shown are supported by the apparatus main body 110 and therefore are not displaced when the housing door 31 is opened. That is, even when the housing door 31 is open, the transfer rollers 12e rotate while holding the sheet of paper P between the transfer rollers 12e, thereby ensuring that the sheet of paper P is transferred.

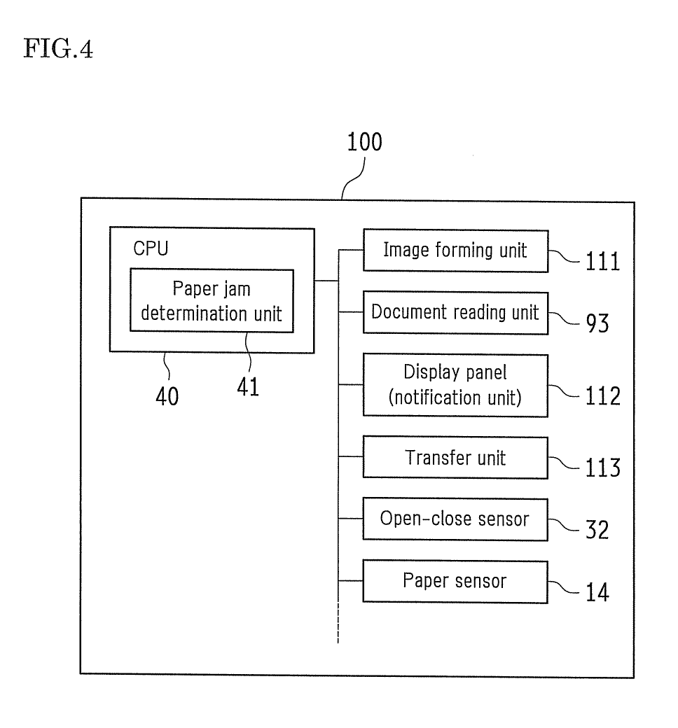

FIG. 4 is a function configuration diagram illustrating a configuration of the functions of the image forming apparatus according to the embodiment of the present invention.

The image forming apparatus 100 according to the embodiment of the present invention includes an image forming unit 111, a document reading unit 93, the display panel 112, a transfer unit 113, the open-close sensor 32, the paper sensors 14, and a paper jam determination unit 41. The transfer unit 113 reciprocatably transfers a sheet of paper P through the paper transfer path S. The open-close sensor 32 detect whether the housing door 31 openable to expose the paper transfer path S is open or closed. The paper sensors 14 are disposed along the paper transfer path S to detect the positions of sheets of paper P. The paper jam determination unit 41 determines whether a paper jam has occurred in the paper transfer path S based on the result of detection by the paper sensors 14. The transfer unit 113 transfers the sheet of paper P in the reverse direction when the paper jam determination unit 41 determines that a paper jam has occurred and when the housing door 31 is opened.

With this configuration, when a paper jam occurs, the sheet of paper P is transferred in the reverse direction to eliminate the paper jam occurring in the paper transfer path S. Additionally, the sheet of paper P is transferred with the paper transfer path S in exposed state, thereby preventing a secondary paper jam.

In this embodiment, the transfer unit 113 corresponds to the pick-up rollers 11a to 11b, the transfer rollers 12a to 12e, and the resist rollers 13.

The paper jam determination unit 41 is implemented by a computer program (computer) built, in advance, in a CPU 40 (Central Processing Unit) disposed in the image forming apparatus 100. When the position of the sheet of paper P remains unchanged for longer than a preset period of time, the paper jam determination unit 41 determines that the sheet of paper P is not being transferred and determines that a paper jam is going on. The paper jam determination unit 41 also determines the number of sheets of paper involved in the paper jam based on the number of the paper sensors 14 detecting sheets of paper.

The image forming apparatus 100 includes a notification unit (for example, the display panel 112) that notifies that the paper jam determination unit 41 determines that a paper jam has occurred. With this configuration, the notification unit makes the user aware of an occurrence of paper jam.

The notification unit notifies that the transfer unit 113 transfers the sheet of paper P in the reverse direction after the housing door 31 is opened. With this configuration, making the user aware in advance that the transfer unit 113 is about to operate eliminates transfer failure caused by the user erroneously trying to remove the sheet of paper P during transfer of the sheet of paper P.

The image forming unit 111 corresponds to the intermediate transfer belt unit 6 and the secondary transfer unit 10.

The document reading unit 93 corresponds to the document reading device 90. The image on the document read by the document reading unit 93 is formed into image onto the sheet of paper P by the image forming unit 111.

Next, an operation of transferring a sheet of paper in the reverse direction when a paper jam occurs will be described by referring to the accompanying drawings. In the following description, the upstream side in the paper transfer path S will be occasionally abbreviated to the upstream side, and the downstream side in the paper transfer path S will be occasionally abbreviated to the downstream side. When a sheet of paper P is transferred in the forward direction, the sheet of paper P is transferred from the upstream side toward the downstream side. When the sheet of paper P is transferred in the reverse direction, the sheet of paper P is transferred from the downstream side toward the upstream side.

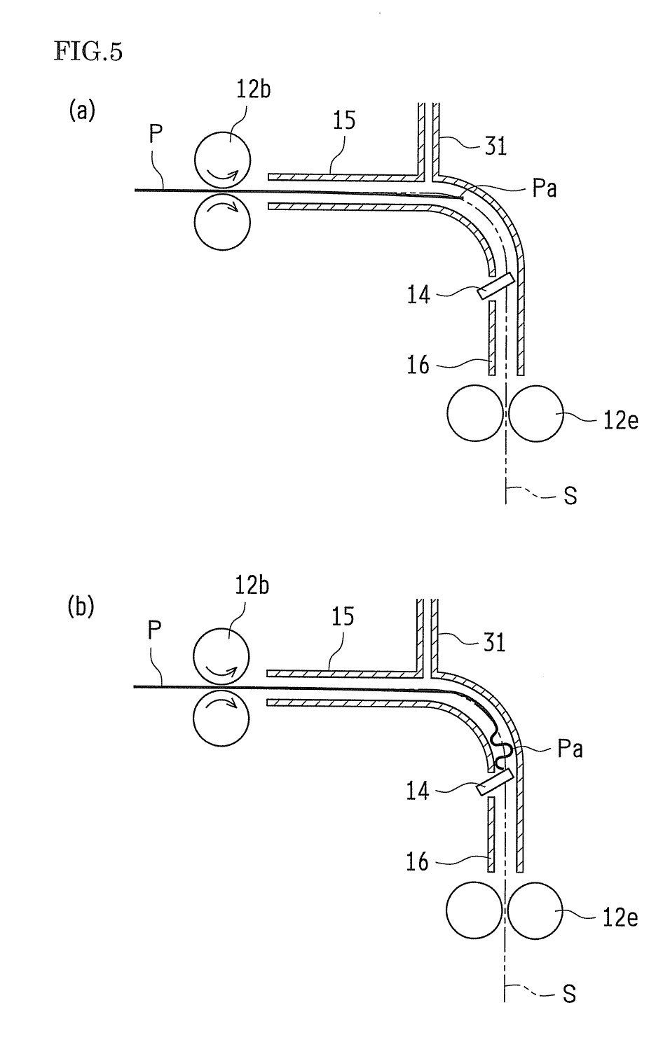

FIG. 5 is a main-elements side view of a part of the paper transfer path in the case of transfer of a sheet of paper with the housing door in closed state, with FIG. 5(a) showing a state before transfer of the sheet of paper and FIG. 5(b) showing a state after transfer of the sheet of paper.

FIG. 5 shows a case of a conventional image forming apparatus, which transfers the sheet of paper P in the reverse direction with the housing door 31 in closed state.

The paper transfer path S (the main transfer path S1 in particular) is held between the transfer path side wall 16, which is formed along the paper transfer path S, and the housing door 31. The spacing between the transfer path side wall 16 and the housing door 31 is approximately equivalent to the thickness the sheets of paper P.

FIG. 5(a) shows a paper jam occurring at the non-exposed portion 15. The sheet of paper P is held between the transfer rollers 12b. A rear end Pa of the sheet of paper P is already past the transfer rollers 12e and the paper sensor 14. That is, the paper sensor 14 is not under pressure of the sheet of paper P and therefore is protruding from the transfer path side wall 16 as if to shield the paper transfer path S.

With the sheet of paper P in this state, the transfer rollers 12b are turned into reverse rotation with the housing door 31 in closed state so as to transfer the sheet of paper P in the reverse direction as shown in FIG. 5(b). Since the paper sensor 14 does not make swinging movement when pressed by a sheet of paper P transferred from the downstream side, the transfer of the sheet of paper P is blocked by the paper sensor 14. Since the housing door 31 is in closed state and thus the paper transfer path S is hermetically sealed, the sheet of paper P can only be transferred in the paper transfer path S. As a result, the rear end Pa of the sheet of paper P is blocked by the paper sensor 14, causing a secondary paper jam to occur.

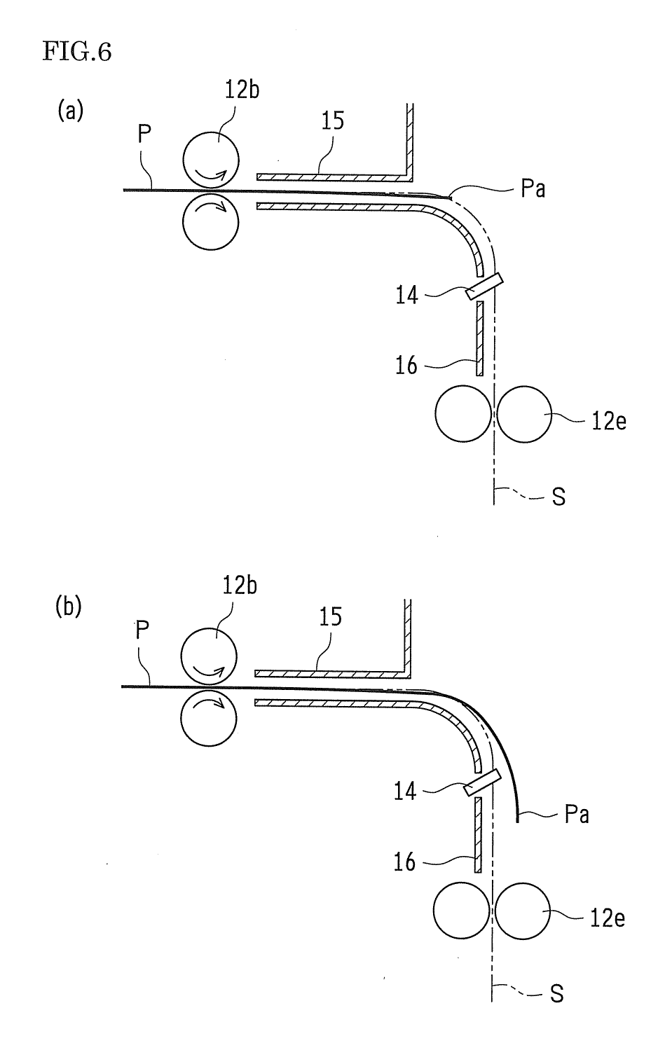

FIG. 6 is a main-elements side view of a part of the paper transfer path in the case of transfer of a sheet of paper with the housing door in open state, with FIG. 6(a) showing a state before transfer of the sheet of paper and FIG. 6(b) showing a state after transfer of the sheet of paper.

FIG. 6 is different from FIG. 5 in that the housing door 31 is open. As shown in FIG. 6, the image forming apparatus according to the embodiment of the present invention transfers the sheet of paper P in the reverse direction with the housing door 31 in open state.

FIG. 6(a) shows a paper jam occurring at the non-exposed portion 15, similarly to FIG. 5(a). The sheet of paper P is held between the transfer rollers 12b. The rear end Pa of the sheet of paper P is already past the transfer rollers 12e and the paper sensor 14. That is, the paper sensor 14 is not under pressure of the sheet of paper P and therefore is protruding from the transfer path side wall 16 as if to shield the paper transfer path S.

With the sheet of paper P in this state, the transfer rollers 12b are turned into reverse rotation to transfer the sheet of paper P in the reverse direction as shown in FIG. 6(b). Although the transfer of the sheet of paper P is temporarily blocked by the paper sensor 14, since the housing door 31 is open, the sheet of paper P moves away from the paper transfer path S to avoid the paper sensor 14. Thus, the sheet of paper P is transferred, preventing a secondary paper jam. The distance over which the sheet of paper P is transferred in the reverse direction is set in advance. In this embodiment, the sheet of paper P is transferred by approximately 100 mm in the reverse direction.

As described above, the image forming apparatus 100 includes the non-exposed portion 15 disposed along the paper transfer path S. The non-exposed portion 15 is not exposed when the housing door 31 is opened. When the paper jam determination unit 41 determines that a paper jam has occurred at the non-exposed portion 15, the transfer unit 113 transfers the sheet of paper P to a part of the paper transfer path S that is outside of the non-exposed portion 15. When a paper jam occurs at the non-exposed portion 15, the sheet of paper P is difficult to remove even by opening the housing door 31. In view of this, in the above-described configuration, the sheet of paper P is transferred to outside of the non-exposed portion 15. This improves workability of the user in removing the sheet of paper P.

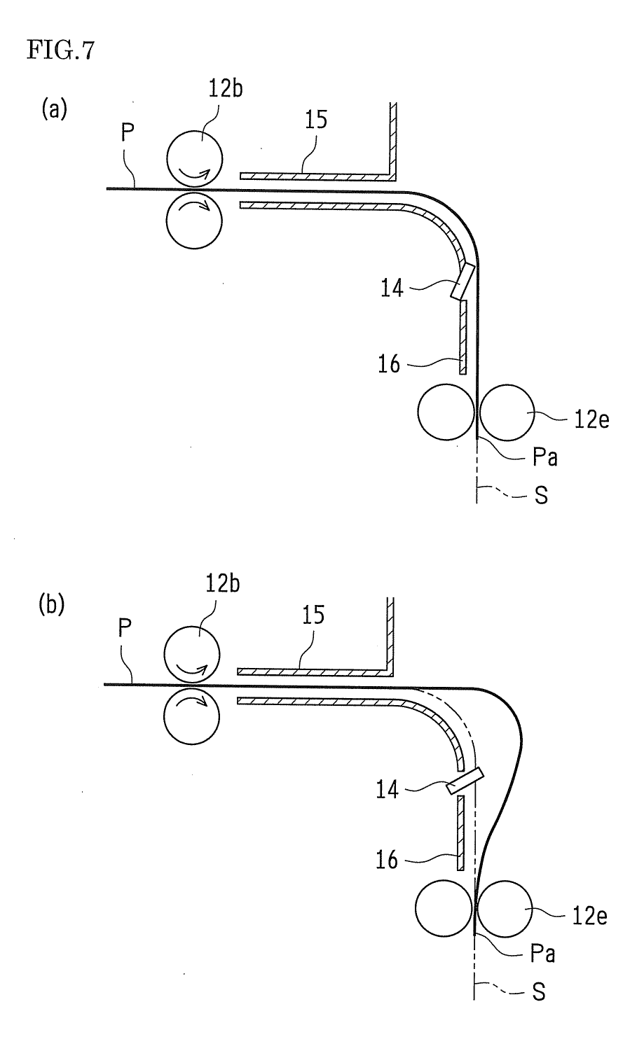

FIG. 7 is a main-elements side view of a part of the paper transfer path in the case of transfer of a sheet of paper held between two transfer rollers, with FIG. 7(a) showing a state before transfer of the sheet of paper and FIG. 7(b) showing a state after transfer of the sheet of paper.

FIG. 7 is different from FIG. 6 in that the sheet of paper P is held between the transfer rollers 12b and between the transfer rollers 12e. The housing door 31 is open. The rear end Pa of the sheet of paper P is not past the paper sensor 14 yet, and thus the paper sensor 14 is pressed by the sheet of paper P and housed in the transfer path side wall 16.

With the sheet of paper P in the state shown in FIG. 7(a), the transfer rollers 12b are turned into reverse rotation with the rear end Pa of the sheet of paper P held between the transfer rollers 12e so as to transfer the sheet of paper P in the reverse direction as shown in FIG. 7(b). Since the rear end Pa of the sheet of paper P is fixed, the part of the sheet of paper P that is not held between the transfer rollers 12b and the transfer rollers 12e moves away from the paper transfer path S, making the sheet of paper P loose. If the sheet of paper P is transferred with the housing door 31 in closed state, the sheet of paper P will not move away from the paper transfer path S, causing a secondary paper jam to occur.

As described above, the transfer unit 113 includes a plurality of roller pairs (for example, the transfer rollers 12a to 12e) that hold the sheet of paper P between each of the roller pairs and rotate so as to transfer the sheet of paper P. When the paper jam determination unit 41 determines that a paper jam has occurred and when the plurality of roller pairs are holding the sheet of paper P between each of the plurality of roller pairs, one roller pair among the plurality of roller pairs disposed on the downstream side of the paper transfer path S rotates. With this configuration, when only one roller pair rotates to transfer the sheet of paper P, the sheet of paper P becomes loose and easier to grasp, thereby improving workability of the user in removing the sheet of paper P.

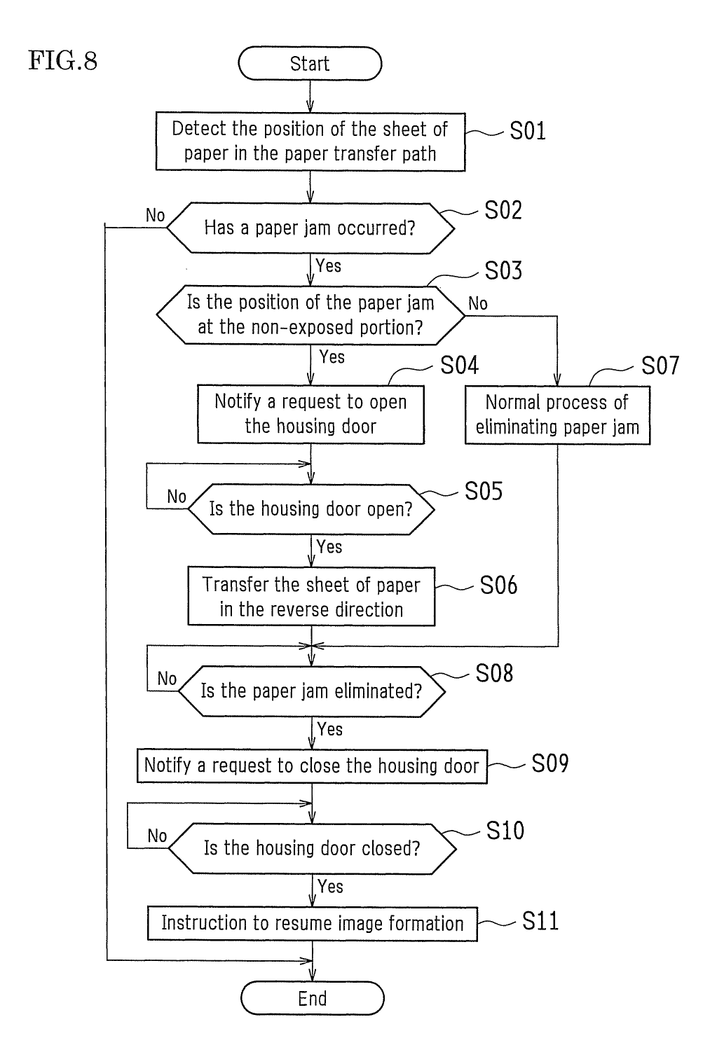

Next, referring to FIG. 8, description will be made with regard to the process of detecting a paper jam and transferring the sheet of paper in the reverse direction in the image forming apparatus according to the embodiment of the present invention. The following process is executed at the time of forming an image onto the sheet of paper.

FIG. 8 is a flowchart of the process of detecting a paper jam and transferring the sheet of paper in the reverse direction in the image forming apparatus according to the embodiment of the present invention.

At step S01, the paper sensor 14 detects the position of the sheet of paper P in the paper transfer path S.

At step S02, the paper jam determination unit 41 determines whether a paper jam has occurred. When the paper jam determination unit 41 determines that a paper jam has occurred (step S02: Yes), the process proceeds to step S03. When a paper jam occurs, the image forming unit 111 is instructed to temporarily stop image formation. When the paper jam determination unit 41 determines that no paper jam has occurred (step S02: No), the process ends.

At step S03, the paper jam determination unit 41 determines whether the position of the paper jam is at the non-exposed portion 15. When the paper jam determination unit 41 determines that the position of the paper jam is at the non-exposed portion 15 (step S03: Yes), the process proceeds to step S04. When the paper jam determination unit 41 determines that the position of the paper jam is not at the non-exposed portion 15 (step S03: No), the process proceeds to step S07.

At step S04, the notification unit (the display panel 112) notifies a request to open the housing door 31. Specifically, the notification unit notifies the user that a paper jam has occurred and that the housing door 31 needs to be opened. The notification unit also notifies that the sheet of paper P will be transferred when the housing door 31 is opened.

At step S05, the open-close sensor 32 determines whether the housing door 31 is open. When the housing door 31 is open (step S05: Yes), the process proceeds to step S06. When the housing door 31 is closed (step S05: No), the process is held until the housing door 31 is opened.

At step S06, the transfer unit 113 transfers the sheet of paper P in the reverse direction. From among the pick-up rollers 11a to 11b, the transfer rollers 12a to 12e, and the resist rollers 13, appropriate rollers are conveniently selected and driven in accordance with the position of the paper jam.

At step S07, a normal process of eliminating the paper jam is executed. Specifically, the display panel 112 indicates an occurrence of paper jam, and the process proceeds to step S08. When the position of the paper jam is not at the non-exposed portion 15, the sheet of paper P may also be transferred in the reverse direction. In this case, after step S07, the process proceeds to step S04.

At step S08, the paper jam determination unit 41 determines whether the paper jam is eliminated. Specifically, the paper jam determination unit 41 determines whether the user has removed the stuck sheet of paper P. When the paper jam determination unit 41 determines that the paper jam is eliminated (step S08: Yes), the process proceeds to step S09. When the paper jam determination unit 41 determines that the paper jam is not eliminated (step S08: No), the process is held until the paper jam is eliminated.

At step S09, the notification unit (the display panel 112) notifies a request to close the housing door 31. Specifically, the notification unit notifies that to resume image formation, the housing door 31 needs to be closed.

At step S10, the open-close sensor 32 determines whether the housing door 31 is closed. When the housing door 31 is closed (step S10: Yes), the process proceeds to step S11. When the housing door 31 is open (step S10: No), the process is held until the housing door 31 is closed.

At step S11, the image forming unit 111 is instructed to resume image formation, and the process ends.

The present invention can be embodied and practiced in other different forms without departing from the spirit and essential characteristics of the present invention. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

What is claimed is:

1. An image forming apparatus provided with a paper transfer path through which a sheet of paper is to be transferred, and provided with a transfer unit configured to reciprocatably transfer the sheet of paper through the paper transfer path, the image forming apparatus comprising:
a housing door openable to expose the paper transfer path;
an open-close sensor configured to detect whether the housing door is open or closed;
a paper sensor disposed along the paper transfer path to detect a position of the sheet of paper; and
a paper jam determination unit configured to determine whether a paper jam has occurred in the paper transfer path based on a result of detection by the paper sensor,
wherein when the paper jam determination unit determines that a paper jam has occurred and when the housing door is opened, the transfer unit is configured to transfer the sheet of paper in a reverse direction.

2. The image forming apparatus according to claim 1, further comprising a notification unit configured to notify that the paper jam determination unit determines that a paper jam has occurred.

3. The image forming apparatus according to claim 2, wherein the notification unit is configured to notify that the transfer unit transfers the sheet of paper in the reverse direction after the housing door is opened.

4. The image forming apparatus according to claim 1, further comprising a non-exposed portion disposed along the paper transfer path, the non-exposed portion being not exposed when the housing door is opened,
wherein when the paper jam determination unit determines that a paper jam has occurred at the non-exposed portion, the transfer unit is configured to transfer the sheet of paper to a part of the paper transfer path that is outside of the non-exposed portion.

5. The image forming apparatus according to claim 1,
wherein the transfer unit comprises a plurality of roller pairs configured to hold the sheet of paper between each of the roller pairs and configured to rotate so as to transfer the sheet of paper, and
wherein when the paper jam determination unit determines that a paper jam has occurred and when the plurality of roller pairs are holding the sheet of paper between each of the plurality of roller pairs, one roller pair among the plurality of roller pairs disposed on a downstream side of the paper transfer path is configured to rotate.
